(19) United States
(12) Patent Application Publication
(10) Pub. No.: US 2026/0110544 A1
(43) Pub. Date: Apr. 23, 2026

(54) SYSTEM

(71) Applicant: SOFTBANK GROUP CORP., Tokyo (JP)

(72) Inventor: Toru KIKUCHI, Tokyo (JP)

(73) Assignee: SOFTBANK GROUP CORP., Tokyo (JP)

(21) Appl. No.: 19/356,543

(22) Filed: Oct. 13, 2025

(30) Foreign Application Priority Data
Oct. 17, 2024 (JP) 2024-181662

(51) Int. Cl. G01C 21/34; G01C 21/36

(52) U.S. Cl. CPC G01C 21/3492; G01C 21/3667

(57) ABSTRACT

A system includes a processor that acquires satellite images and three-dimensional map data, generates traveler profile information using the acquired information, dynamically selects a travel route based on external factors, and presents the travel route on a display device.

### CROSS-REFERENCE TO RELATED APPLICATION

This application is based on and claims priority under 35 USC 119 from Japanese Patent Application No. 2024-181662 filed on Oct. 17, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional route guidance systems often fail to provide optimal travel routes that fully consider real-time environmental changes and individual user characteristics, such as mobility constraints and personal preferences. Furthermore, such systems rarely adapt dynamically to unexpected events or learn from user feedback, resulting in inconvenient, inefficient, or inaccessible route suggestions for travelers, especially those with special requirements.

### SUMMARY

The present invention provides a system comprising a processor that acquires satellite images and three-dimensional map data, generates traveler profile information using the acquired information, dynamically selects travel routes based on external factors, and presents the routes on a display device. The processor further updates the route generation in real time in response to changing external conditions during travel, and incorporates a feedback learning function that adapts the route algorithm based on traveler feedback, thereby ensuring provision of safe, efficient, and personalized travel routes.

“Processor” means a hardware or software component responsible for executing data processing and control functions within the system.

“Satellite images” means pictures or data of the Earth’s surface captured from satellites, providing geographical and environmental information.

“Three-dimensional map data” means digital representations of geographical areas including elevation, structure, and spatial relationships in three axes (x, y, z).

“Traveler profile information” means personalized information about the traveler, including physical characteristics, historic travel preferences, and specific needs.

“External factors” means environmental variables such as weather conditions, ongoing events, traffic, and obstacles that may affect travel routes.

“Travel route” means a path or series of directions generated by the system to guide a traveler from a starting point to a destination.

“Display device” means any equipment or interface capable of visually presenting information to the user, such as a screen or graphical user interface.

“Feedback learning function” means a mechanism by which the system collects input from the traveler and uses it to adapt and improve the route generation algorithm.

“Route generation algorithm” means a computational method or set of rules used by the processor to determine the most suitable travel route based on available data.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

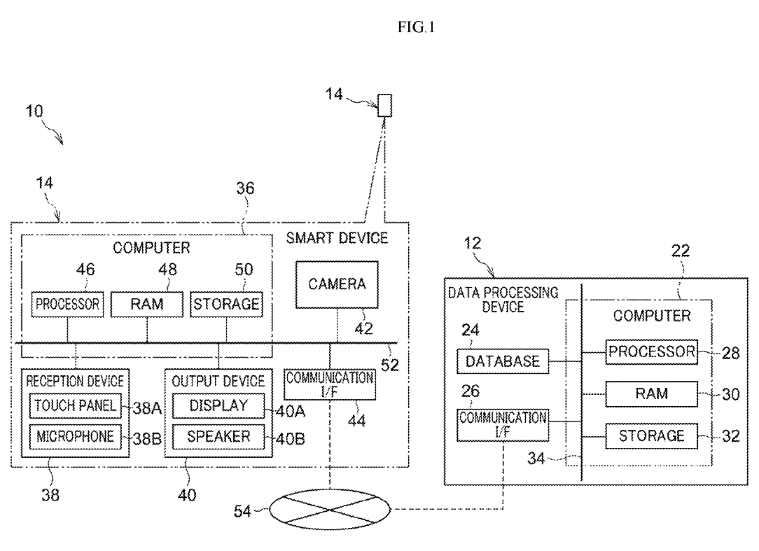

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

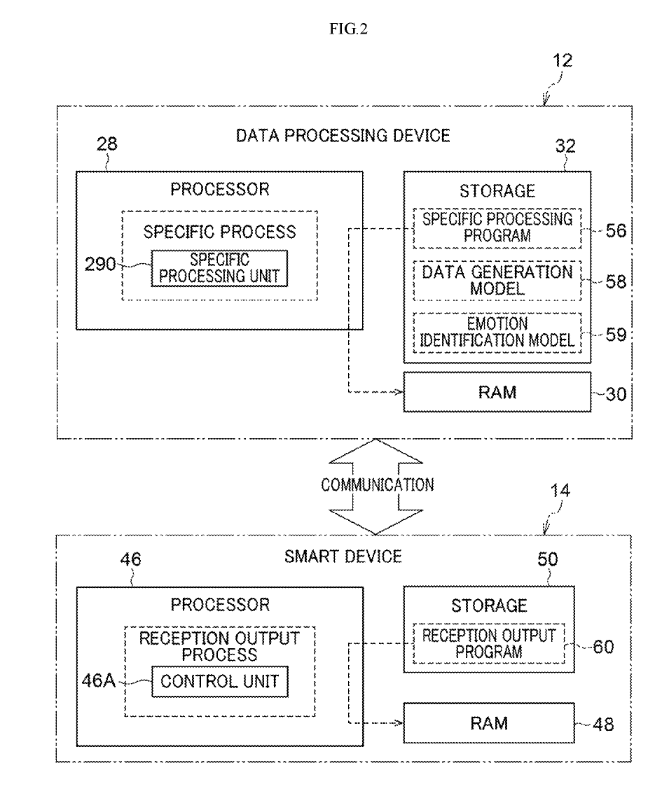

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent years, the selection of movement routes has become increasingly complex due to the diversification of transportation methods and rapid changes in external environments such as weather and road conditions. Conventional navigation systems are unable to flexibly and quickly respond to individual requirements, especially for persons with mobility constraints such as wheelchair users or elderly people. There is a need for a system that can dynamically generate and adapt optimal movement routes for each user in real time, taking into account ongoing changes and individual user conditions.

The specific processing by the specific processing unit 290 of the data processing device 12 in Example 1 is realized by the following means.

The present invention provides a server comprising a processor configured to acquire position, terrain, and weather information from external sources; generate an attribute profile of a mobile subject based on such information and their past movement history; dynamically generate candidate movement routes by inputting environmental information and attribute information into a generative artificial intelligence model using a prompt sentence; visually present multiple candidate movement routes on an output device for user selection; detect changes in external environment or the subject’s condition and regenerate candidate routes in real time; and continuously train the generative artificial intelligence model using feedback such as route selection history and environmental data. This enables the provision of highly adaptable and personalized route guidance for users, allowing real-time optimization and flexible response to changing circumstances and individual needs.

The term “position information” refers to data that specifies the geographical location of a subject, typically expressed in coordinates such as latitude and longitude.

The term “terrain information” refers to data representing the physical features, elevation, and structure of the Earth's surface in a given area.

The term “weather information” refers to data indicating atmospheric conditions such as temperature, precipitation, wind speed, and other meteorological variables for a specific location and time.

The term “external information sources” refers to systems or services outside the claimed system that provide data, such as satellite navigation networks, weather data providers, or geographic information systems.

The term “mobile subject” refers to a person or object that is capable of moving along a path or route, and for whom the route is being optimized.

The term “attribute information” refers to a dataset representing the characteristics, preferences, constraints, and past movement history of a mobile subject.

The term “past movement history” refers to recorded data detailing previous routes, travel patterns, speeds, and preferences associated with a mobile subject.

The term “environmental information” refers to data related to external factors affecting a route, including position, terrain, weather, or any real-time changes in those factors.

The term “generative artificial intelligence model” refers to a computerized algorithm that produces new data or solutions, such as route options, by processing input data and prompt sentences using machine learning or deep learning techniques.

The term “prompt sentence” refers to a natural language text input that instructs or guides the generative artificial intelligence model to output a desired solution or candidate route based on given conditions.

The term “candidate movement routes” refers to several alternative paths generated for a mobile subject to travel from an origin to a destination, considering environmental and attribute information.

The term “output device” refers to a user interface apparatus such as a graphical display, touch panel, or audio system that presents information, including candidate movement routes, to a user.

The term “feedback information” refers to data collected from user interactions, such as selected routes, deviations, or environmental updates, which is used to improve or optimize system performance.

The term “route generation algorithm” refers to a set of computational procedures implemented to compute optimal or suggested movement routes based on input information.

### Embodiment for Practicing the Invention

The present invention can be practiced using a system including a server equipped with a processor, a terminal device such as a smartphone or tablet, and a user interface implemented on the terminal. The system is designed to acquire position information, terrain data, and weather information from various external information sources, generate personalized profiles for mobile subjects based on past movement history, and dynamically create and offer optimized movement routes using a generative artificial intelligence model that utilizes prompt sentences.

The server executes acquisition of position information using a global navigation satellite system (GNSS) module, such as a GPS receiver integrated in the terminal. Real-time terrain information and weather data are obtained by the server using external data service APIs, for example, a geospatial data provider and a weather information API. The server processes these various datasets using data analysis software libraries such as Python, Pandas, or NumPy.

The terminal device tracks the user’s movements through the embedded GPS sensor, logs the user’s movement history, and detects settings such as accessibility features, for example, wheelchair mode being activated. The terminal generates attribute information of the user and periodically transmits the profile to the server via secure application protocols. The server inputs environmental and attribute data into a generative AI model, such as an implementation based on TensorFlow, PyTorch, or an external large language model service. The server constructs a prompt sentence in natural language that reflects the current situation and the user’s specific needs and passes this prompt, together with the structured data, to the AI model. For example, the server may use as a prompt:

“Propose a safe and efficient route for a wheelchair user, avoiding outdoor exposure during rainfall and prioritizing covered pedestrian paths. Current location: Tokyo Station. Destination: Otemachi Building.”

The AI model generates one or more candidate movement routes, which the server sends to the terminal device. The terminal visually presents these routes on a graphical user interface implemented with SDKs such as Mapbox or generic map rendering tools. The user selects a preferred route via touch operation.

During movement, the terminal uses sensor data (for example, an accelerometer or barometer) and periodic GPS updates to detect events such as unexpected obstacles, road work, or rapid weather changes. The terminal transmits this feedback to the server in real time. Upon detecting such changes, the server generates a new prompt sentence to the generative AI model:

“Suggest an immediate alternate route; road construction detected at point X; prioritize user safety.”

and produces updated route options accordingly.

The server continually accumulates feedback data, such as route selections and deviations, into a cloud database (for example, using a database service), and periodically retrains the generative AI model to refine and improve future route generation performance. This enables the system to adapt to user preferences and changing environments with high flexibility.

As a specific example, if a user operating a wheelchair needs to travel from one location to another during a rainstorm, the system will collect the latest weather forecasts, assess current location and route accessibility, and prompt the AI:

“Generate the best possible covered route for a wheelchair user from current location to destination, avoiding outdoor exposure during rain.”

The terminal then displays multiple covered route choices, and the user selects a route based on individual priorities such as shortest distance or maximum coverage.

This embodiment allows the invention to offer highly customizable and adaptive route guidance, providing a safe and convenient travel experience tailored to each user’s mobility characteristics and the real-time state of the external environment.

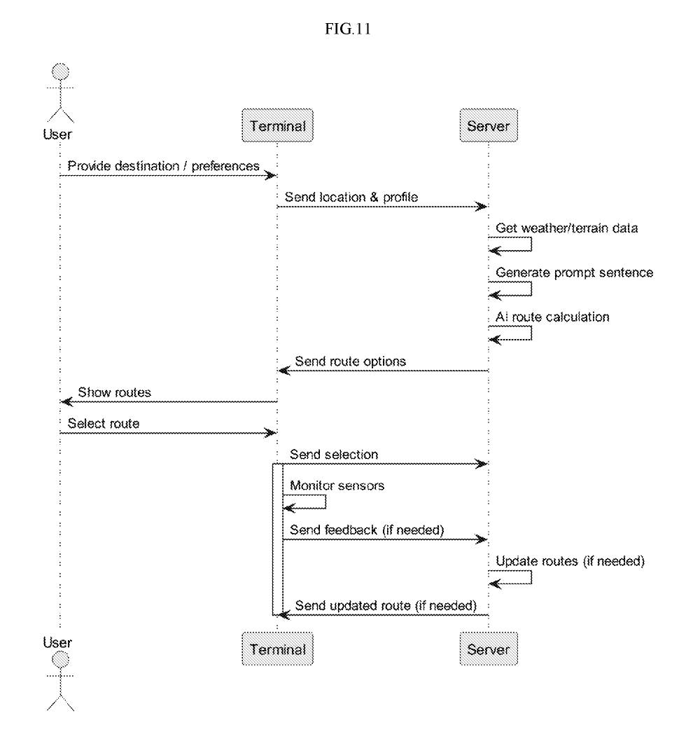

The following describes the processing flow using FIG. 11.

Step 1:

The terminal acquires the current location of the user using an embedded GNSS module such as a GPS sensor. The terminal also detects active accessibility settings, including wheelchair mode or voice guidance preferences. The terminal sends the user's current position data, device settings, and a record of its movement history to the server using a secure communication protocol. The input for this step includes live GPS coordinates and movement logs. The output is a data packet containing location and user settings, transmitted to the server.

Step 2:

The server receives the data from the terminal, and then retrieves supplemental terrain and weather information by querying external data providers such as geospatial and weather APIs. The server merges the incoming user data with real-time environmental data using data handling software such as Python or Pandas. The input for this step includes user position, profile information, terrain data, and weather conditions. The server processes and normalizes this data into structured records, and the output is a comprehensive dataset describing the user's environment and mobility profile.

Step 3:

The server generates a natural language prompt sentence that describes the user’s current needs and environmental context (for example, “Propose a safe and efficient route for a wheelchair user, avoiding outdoor exposure during rainfall and prioritizing covered pedestrian paths.”). The server feeds both the prompt and structured environmental data into a generative AI model implemented with a platform such as TensorFlow, PyTorch, or an external large language model service. The input is the generated prompt sentence and the processed dataset from Step 2. The server executes inference processing in the AI model, and the output is a set of candidate movement routes, each described as a sequence of geo-coordinates and accompanied by qualitative route explanations.

Step 4:

The terminal receives the list of candidate movement routes from the server over a secure channel. The terminal parses the route data and visually displays each option on its graphical user interface, using a mapping toolkit such as Mapbox. The input is the set of candidate routes with their metadata. The terminal color-codes covered and uncovered sections, offers route explanations, and enables the user to select a route via touch interface. The output of this step is the user's selected route, which is sent back to the server as a confirmation.

Step 5:

The user follows the selected movement route as presented by the terminal. While traveling, the terminal continually monitors the sensor suite (such as accelerometer and GPS) for deviations such as route diversion or unanticipated stops. The terminal periodically checks external environment updates, such as sudden weather changes or road blockages. The input is ongoing sensor and environmental data. When a disruption or update is detected, the terminal immediately sends this feedback, along with the current position, to the server. The output is a feedback and updated context data packet.

Step 6:

The server receives real-time feedback and context data from the terminal. The server analyzes the new information and, if necessary, generates a new prompt sentence reflecting the updated circumstances (for example, “Suggest an immediate alternate route; road construction detected at point X; prioritize user safety.”). The input is feedback from the movement context and any environmental change. The server processes this input with the AI model to recalculate suitable alternative routes, and the output is an updated set of candidate movement routes, which are immediately transmitted to the terminal for the user.

Step 7:

The server stores user route selections, sensor data, feedback, and route deviation logs in a database. At scheduled intervals, the server uses this accumulated data to retrain or refine the generative AI model using machine learning software frameworks. The input is route history and feedback data collected over many user sessions. The output is an updated AI model with improved accuracy and responsiveness in generating optimal routes for future users.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In current mobile and autonomous guidance technologies, it is difficult to rapidly and flexibly respond to real-time changes in external environments or the individual needs and conditions of users. Conventional systems often lack the ability to dynamically generate optimal movement routes reflecting external factors, user characteristics, and unpredictable events during movement. Furthermore, these systems do not sufficiently utilize artificial intelligence to personalize recommendations or learn from user feedback and biometric states. As a consequence, these limitations hinder the provision of safe, efficient, and comfortable navigation, especially for individuals requiring specific assistance or preferences.

The specific processing by the specific processing unit 290 of the data processing device 12 in Application Example 1 is realized by the following means.

The present invention provides a server comprising a processor configured to acquire external information including geographical and environmental data, generate attribute information of an individual based on the collected data, generate a movement route based on such attribute information and external factors, generate an output prompt sentence for a generative artificial intelligence model to calculate an optimal route, process the output of the generative artificial intelligence model, and present the result to a display device. This enables the system to dynamically provide optimal navigation routes in real time, flexibly respond to environmental and user-specific changes, leverage biometrics and generative artificial intelligence for personalization, and continuously improve route generation and movement control based on user feedback and biometric information.

The term “processor” refers to an apparatus or unit configured to execute programmed instructions and perform computational operations, including data acquisition, analysis, and control tasks within the system.

The term “external information” refers to data obtained from sources outside the system, including but not limited to geographical information, environmental information, weather data, and event data relevant to route generation.

The term “geographical information” refers to data representing physical features and spatial characteristics of a given area, such as map data, location coordinates, elevation, and three-dimensional topography.

The term “environmental information” refers to data describing external conditions in a given area, including weather, climate, road conditions, and temporary events or obstacles that can affect movement.

The term “attribute information” refers to a set of characteristics generated to represent an individual user, such as movement preferences, physical conditions, behavior patterns, and historical data.

The term “movement route” refers to a series of locations, directions, and instructions generated to guide an individual from a starting point to a destination based on attribute information and external factors.

The term “external factors” refers to dynamic influences occurring outside the individual, such as environmental changes, social events, or obstacles, which may affect route determination.

The term “output prompt sentence” refers to a structured text or data string generated to instruct a generative artificial intelligence model to perform a specific calculation or reasoning task, typically involving route optimization.

The term “generative artificial intelligence model” refers to an artificial intelligence system capable of creating new data outputs, such as routes or recommendations, by processing input data, including prompt sentences, based on learned patterns or algorithms.

The term “display device” refers to any interface device, such as a screen or audio system, used to present information or guidance to the user.

The term “biometric states” refers to measurable physiological or behavioral data related to the user, such as emotional signals, health status, or movement patterns, which can influence route generation and system personalization.

The term “user selection results” refers to data representing the choices or preferences indicated by the user in response to presented options or guidance.

The term “operation algorithm” refers to a set of logical procedures or mathematical formulas executed by the processor or artificial intelligence model to perform tasks related to route generation, evaluation, and adaptation.

The term “learn and improve” refers to the process by which system algorithms or models adjust and enhance their operation through feedback, historical data, biometric input, or user interactions to provide more accurate or effective recommendations.

One embodiment of the invention will be described in detail below.

The present invention can be implemented as a system comprising a server, a terminal, and one or more users. The server includes a processor and storage device. The terminal may be a mobile device, an in-vehicle controller, or a dedicated navigation device equipped with input/output interfaces and sensors. The following describes the principal hardware and software components as well as concrete methods for manufacturing and operating the system.

The server acquires external information, including geographical and environmental data, using information retrieval software such as API clients or web scraping scripts. These software modules can interface with mapping services, weather data sources, and event information platforms. Geographical information may consist of satellite images and three-dimensional geographic map data obtained via external data providers. Environmental information may include weather forecasts, accident reports, or event schedules collected from government or private data APIs. The server uses a database management system such as PostgreSQL (with PostGIS extension for spatial data) to organize and store these data.

The terminal collects attribute information about the individual user. The terminal may include a GPS module, an accelerometer, and wireless interfaces such as Bluetooth to detect physical aid devices. The terminal runs local software, which may be implemented using a mobile operating system, with services written in standard programming languages such as Java, Kotlin, Swift, or C++. These programs analyze the user’s historical movement data and current status to assemble a user profile, including features such as movement preferences, accessibility needs, and behavioral patterns. Additionally, the terminal can be equipped with a camera and microphone, and run software such as TensorFlow Lite or embedded emotion-detection algorithms to infer the user's biometric state, such as level of stress, using voice and image analysis.

The server receives user profile data and integrates it with the environmental and geographical information. The processor normalizes, encodes, and consolidates the aggregated data. It is configured to formulate an output prompt sentence, which comprises a natural language instruction embedding all the observed constraints and requirements. This prompt sentence is provided to a generative artificial intelligence model, which may consist of a cloud-based machine learning framework, for example, an instance of a large language model or transformer network running on a dedicated cloud-based GPU cluster.

The generative AI model processes the prompt sentence and outputs an optimal movement route that consists of a sequence of waypoints and step-by-step instructions. The processor parses the response, attaches supplemental data (such as estimated time of arrival or warnings), and transmits the navigation guidance to the terminal.

The terminal presents the navigation results to the user through a graphical user interface or voice output. The user interacts with the terminal to select among presented options. If the user or the environment undergoes further changes, such as a detected road closure or a newly measured increase in the user's stress level, the terminal updates the server with this new information. The server then generates a new prompt sentence reflecting the latest situation and repeats the above process in real time.

As a concrete example, assume a user who requires wheelchair access is navigating a city during rainy weather. The terminal, through app analysis of recent travel logs, recognizes the user's need to avoid stairs and crowded areas. The server receives weather information predicting heavy rainfall and nearby event data, noting a parade that is likely to cause localized congestion. The server creates an output prompt sentence such as:

"Current location: Tokyo Station. Destination: Imperial Palace. User requires accessible path (wheelchair), route must avoid ongoing parades, heavy rain, and must minimize waiting at crosswalks. Give step-by-step directions and suggest alternatives if obstructions are detected en-route."

This prompt sentence is input to the generative AI model, which returns a sequence of waypoints, for example, via underground passages and covered sidewalks, and the server sends the updated instructions to the terminal. If a sudden road closure or increase in measured user stress occurs, updated feedback is sent to the server, a revised prompt sentence is generated, and alternative routes are provided in real time.

Through this configuration, the invention enables efficient and adaptive navigation tailored to individual needs, supported by the synergistic use of external data sources, real-time feedback, generative AI, and biometric state analysis, and may be implemented using standard hardware and modern machine learning toolsets.

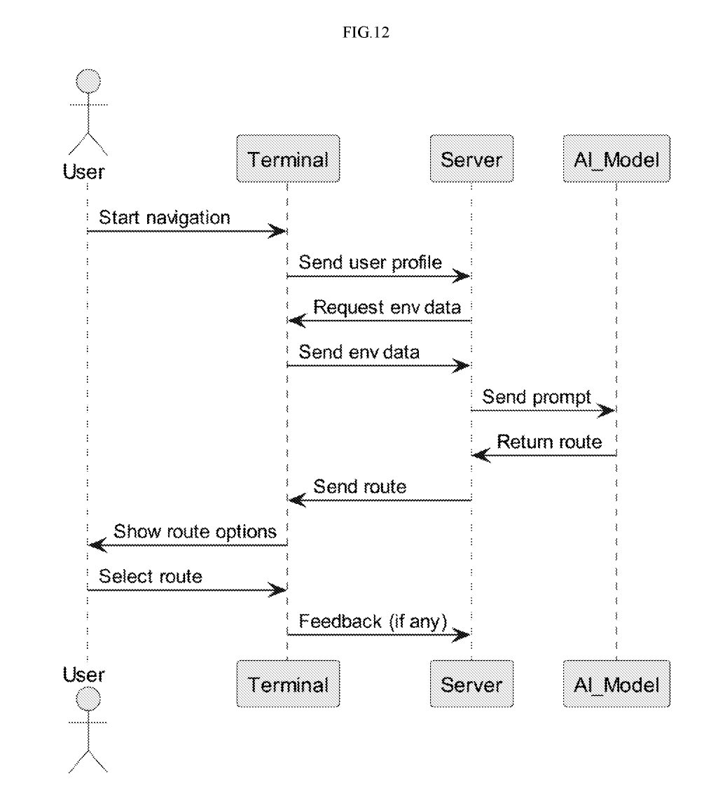

The following describes the processing flow using FIG. 12.

Step 1:

The server acquires external information by connecting to external data sources, such as map services, weather data providers, and event notification platforms. The server receives inputs including satellite images, three-dimensional geographical data, weather forecasts, and event schedules. The server processes these data to normalize formats, extract relevant features (such as road closures or weather hazards), and stores the processed results in a database. The output is a structured and updated set of geographical and environmental data.

Step 2:

The terminal collects user-specific data by analyzing inputs such as GPS location history, sensor data (from accelerometers, Bluetooth connections to assistive devices), and user settings (e.g., accessibility requirements). The terminal may also capture real-time biometric data via microphone and camera to infer the user's emotional state. The terminal processes these inputs using embedded software, performing pattern analysis and feature extraction, and generates a user profile containing movement preferences, physical limitations, and current biometric state. The output is a user profile that is transmitted to the server.

Step 3:

The server integrates the received user profile with the processed geographical and environmental data. Inputs consist of the user profile data from the terminal and the environment data from the database. The server performs data fusion, aggregates features into a comprehensive dataset, and encodes key variables (such as user constraints and real-time hazards) to prepare them for artificial intelligence processing. The output is a consolidated scenario dataset for route computation.

Step 4:

The server generates a prompt sentence for the generative AI model. The input is the consolidated scenario dataset including user profile, environment, and constraints. The server encodes this data as a detailed, natural language instruction containing all required information and passes it to the generative AI model through an API. The output is a prompt sentence sent to the AI model.

Step 5:

The generative AI model calculates an optimal movement route by interpreting the prompt sentence. The input is the prompt generated in Step 4. The model performs reasoning, optimization, and route-planning based on its training and the provided constraints. The output is a set of instructions describing the optimal route, including waypoints, directions, estimated arrival time, and alternative suggestions.

Step 6:

The server receives the route generated by the generative AI model. The input is the AI-generated route and related instructions. The server parses and formats this information, appends any additional data (such as warnings or priority rankings), and transmits the final navigation data to the terminal. The output is a structured guidance dataset sent to the terminal.

Step 7:

The terminal presents route options to the user through a graphical user interface or, if required, through audio instructions. The input is the navigation dataset from the server. The terminal visualizes alternative routes, displays ETA, hazards, and indicates the suitability with respect to user preferences and physical conditions. The output is a set of presented route options for user selection.

Step 8:

The user selects a preferred route using the terminal's input interface, such as touch, voice commands, or control buttons. The input is the choice of route options presented in Step 7. The user’s selection is received, and in the case of an autonomous vehicle, the terminal transmits the navigation commands to the vehicle control system. The output is a confirmation of the selected route and the initiation of movement along that route.

Step 9:

During navigation, the terminal continuously monitors real-time changes in the environment and the user’s biometric state using sensors (camera, microphone, GPS, etc.). The input is real-time sensor data and user activity during travel. The terminal processes these signals using embedded analysis algorithms, detects events or abnormal states (such as new obstacles, elevated stress levels, or environmental changes), and sends updated information to the server when necessary. The output is real-time feedback data provided to the server.

Step 10:

The server updates its scenario dataset upon receiving real-time feedback. The input is the updated environmental or biometric information from the terminal. The server re-generates a prompt sentence that includes the new situation and submits it again to the generative AI model. The AI model calculates a revised optimal route, and the server pushes the updated instructions back to the terminal. The output is an updated movement route adapted to the new conditions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional navigation and route selection systems typically propose paths based solely on geographic information, traffic, or preset preferences, without consideration for the user's real-time emotional state or psychological comfort. As a result, such systems are unable to dynamically adapt to the emotional needs of individual users, risking the provision of routes that may contribute to greater stress, discomfort, or dissatisfactory user experiences during transit. There thus exists a need for a route proposal system that provides personalized, emotion-aware travel experiences by optimizing routes according to user-specific behavioral patterns, emotional conditions, and external circumstances.

The specific processing by the specific processing unit 290 of the data processing device 12 in Example 2 is realized by the following means.

The present invention provides a server comprising a processor configured to acquire spatial information, determine a user's emotional state based on audio or video input, generate individual characteristic information using behavioral and emotional history, and employ a generative artificial intelligence model to dynamically generate and display travel routes that reflect emotional state and external factors. This enables the system to provide each user with continuously optimized, emotion-sensitive route guidance that adapts in real-time to feedback and changing user conditions, thereby improving comfort, satisfaction, and personalization throughout the journey.

The term “spatial information” refers to data representing the geographical features, location, and environment of a specific area, including but not limited to satellite images, three-dimensional map data, and topographical information.

The term “information acquisition unit” refers to a component or module configured to obtain spatial information from external sources such as mapping databases, geolocation data providers, or remote sensing systems.

The term “audio information” refers to sound-based digital data recorded or captured from the user, including spoken words, vocal tones, and other acoustic signals that convey information about the user's state.

The term “video information” refers to visual digital data captured by an image sensor, such as a camera, representing the appearance, expressions, or gestures of the user.

The term “emotion recognition unit” refers to a component or module configured to analyze audio information and/or video information to determine or classify a user's emotional state using methods such as feature extraction, pattern recognition, or machine learning.

The term “emotional state” refers to the psychological or affective condition of the user at a particular time, including but not limited to states such as stress, calmness, happiness, anxiety, or frustration.

The term “behavioral history information” refers to accumulated data describing the user’s past actions, movements, and travel patterns, typically obtained through sensors, navigation logs, or location tracking devices.

The term “characteristic information generation unit” refers to a component or module configured to create individualized profiles, preferences, or user models based on behavioral history information and emotional state information.

The term “external information” refers to data external to the user, such as weather conditions, traffic reports, environmental factors, or location-specific events, that may influence route selection.

The term “generative artificial intelligence model” refers to a machine learning system or algorithm capable of producing new content, output, or solutions—in this context, generating customized route recommendations—on the basis of prompts and input data.

The term “prompt sentence” refers to a structured natural language statement or query that is provided as input to the generative artificial intelligence model to initiate or guide the generation of an output.

The term “route generation unit” refers to a component or module configured to select, calculate, or generate travel routes for the user, taking into account characteristic information, emotional state, external information, and the output of a generative artificial intelligence model.

The term “presentation unit” refers to a component or module configured to output or communicate information to the user, including but not limited to visual or auditory presentation of the generated travel route via a display device.

The term “feedback information” refers to responses, evaluations, or ratings provided by the user after or during a travel experience, which may be utilized to improve or adapt subsequent route recommendations.

The term “display device” refers to any device capable of presenting visual or auditory output to a user, including but not limited to screen-based and voice-based interfaces on mobile terminals or computing apparatuses.

An embodiment of the present invention enables the realization of a system for providing personalized, emotion-aware navigation using a combination of sensor-equipped terminal devices, servers with high computational capability, and generative artificial intelligence models. The system is designed such that the terminal and the server communicate via a network, and each component performs dedicated processing for optimizing user routing experiences.

The server comprises a processor capable of acquiring spatial information, such as satellite images and three-dimensional map data, from geographic information system (GIS) platforms and weather application programming interfaces (APIs). As illustrative examples, the server may utilize mapping service APIs from general providers, as well as weather APIs delivering up-to-date environmental data. The spatial and environmental data are stored and managed on a database, such as a relational database system (e.g., PostgreSQL with PostGIS extension).

The terminal, which may be a general-purpose smartphone or a mobile computing apparatus equipped with a camera, microphone, global positioning system (GPS) receiver, and sufficient processing hardware, functions as the user interface and primary sensor. The terminal collects audio and video information from the user using its microphone and camera. Software modules within the terminal, developed using machine learning frameworks such as TensorFlow Lite or equivalent emotion recognition libraries, process this sensor data in real-time. Using machine learning models, the terminal classifies the user's emotional state (such as “stressed”, “relaxed”, or “anxious”) based on detected facial features and vocal characteristics.

Additionally, the terminal stores and manages behavioral history information, such as the user’s past movement paths, preferred locations, and frequently visited areas, in local storage (e.g., SQLite database). This data is continually updated and correlated with current and past emotional state information to generate individualized characteristic information for each user. The terminal encrypts this characteristic information and transmits it to the server using a secure network protocol.

Upon receiving the characteristic information and the latest external information, the server configures a prompt sentence in natural language, which, together with the user profile and relevant environmental context, serves as input for the generative artificial intelligence model. The server may utilize a generalized natural language processing API, such as a large language model service, capable of adapting its output according to highly contextualized prompts. The server operates the generative artificial intelligence model to generate one or several optimal travel route options, taking into account the user’s emotional profile and changing external factors. Example prompt sentences include:

“Create a stress-free walking route from Tokyo Station to Ueno Park, using paths with less vehicular noise, and avoiding crowds, for a user feeling anxious today.”

“Suggest a commuting route that maximizes exposure to green spaces and has shelter options in case of rain, for a user who appears fatigued.”

“Reroute immediately to avoid central crossing due to user frustration, and provide calming street-side park options.”

The generated route, including detailed waypoints and annotated metadata (such as comfort level, estimated travel time, and environment type), is formatted and transmitted from the server to the terminal.

The terminal, upon receiving an updated route, presents the results to the user via a display device or an auditory interface, such as the smartphone’s screen or speaker system. Visual representations may highlight recommended relaxing zones, such as parks or less crowded backstreets, and the terminal may also issue audio instructions intended to promote comfort. The user is thus guided along a dynamically optimized path that is tailored to both their emotional and contextual needs.

During travel, the terminal continues to monitor the user's emotional state and environment. If a change is detected—such as increased anxiety or environmental disturbances—the terminal collects new sensor data and initiates the feedback process. The server then dynamically updates the generative AI prompt sentence and recalculates the route as needed. Furthermore, after the trip, the user may provide explicit feedback or satisfaction ratings, which the system employs for additional adaptive learning.

In this manner, a user can benefit from a highly adaptive and personalized navigation experience, achieved through the synergistic use of geographical data acquisition, real-time emotion recognition, behavioral profiling, generative artificial intelligence modeling, and user-centered feedback.

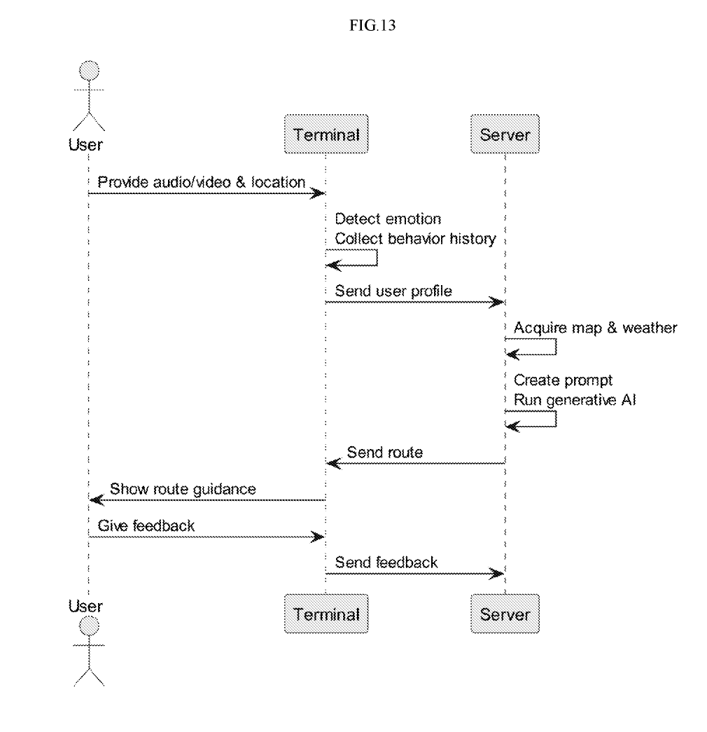

The following describes the processing flow using FIG. 13.

Step 1:

The server acquires spatial information by sending requests to geographic information system APIs and environmental data sources. As input, the server receives area identifiers or user location data. The server retrieves satellite images, three-dimensional map data, and real-time weather information. Using parsing and validation algorithms, the server processes these data streams and stores them in a spatial database. The output is a structured dataset of spatial and environmental information tagged with location and time.

Step 2:

The terminal captures audio and video information from the user through its microphone and camera. As input, the terminal receives sensor data corresponding to the user's environment and facial/voice data. The terminal applies an embedded emotion recognition model (e.g., TensorFlow Lite) on the input data, extracting relevant features and classifying the user's emotional state. The output of this step is a timestamped emotional state label.

Step 3:

The terminal collects behavioral history information by gathering the user’s recent location data and movement patterns from GPS logs and application history. It then combines this data with the emotional state output from Step 2. The terminal processes these inputs by analyzing correlations and trends using a data processing algorithm to generate individual characteristic information, such as personalized route preferences. The output is an encrypted user profile containing behavioral and emotional metadata.

Step 4:

The terminal transmits the generated user profile to the server via a secure network connection. As input, the server receives the user profile and the most recent spatial and environmental data from Step 1. The server formulates a prompt sentence that summarizes the user's emotional condition, characteristic information, and external context. The server then submits this prompt and the associated data to a generative AI model. The AI model processes the prompt by reasoning about optimal route configurations and generates a recommended travel route adapted for the user’s circumstances. The output is a detailed route plan including waypoints and contextual annotations.

Step 5:

The terminal receives the generated route from the server as input. The terminal parses the route data and presents it to the user visually on its display, highlighting elements such as relaxing areas or comfort scores, and/or audibly via its speaker. The terminal uses a navigation application to guide the user along the selected route, providing real-time instructions and comfort notifications. The output is an interface through which the user can easily follow the personalized and emotion-aware route guidance.

Step 6:

The user traverses the recommended route and interacts with the terminal as needed. If the user's emotional state changes during navigation, the terminal collects new audio/video input as before, processes this input to detect the updated emotional condition, and returns to Step 3. The input here is new user emotion and context data; the output is updated emotional metadata and, ultimately, dynamic adaptation of route guidance.

Step 7:

After route completion, the user provides feedback through the terminal, such as satisfaction ratings or comments. The terminal sends this feedback to the server. The server receives the input and uses it to update the user profile or retrain the generative AI model for better personalization. Data processing algorithms analyze the feedback, and the output is a refined system response that will improve future route recommendations for the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional navigation and travel route recommendation technologies primarily consider external factors such as geographic information and real-time traffic conditions, but are insufficient in providing personalized travel routes that adapt to the psychological or emotional state of the user. As a result, users may experience discomfort or stress during travel, as the proposed routes do not adequately account for individual psychological needs or preferences in real time.

The specific processing by the specific processing unit 290 of the data processing device 12 in Application Example 2 is realized by the following means.

The present invention provides a server comprising means for acquiring geospatial information data and spatial structure data, analyzing user emotion state data to generate user characteristic information, generating an optimal travel route using a generative information processing model based on the user characteristic information and geospatial information data, and presenting the generated optimal travel route to a visualization device. This enables dynamic and emotion-adaptive generation and presentation of personalized travel routes, thereby improving user comfort and satisfaction during travel.

The term “geospatial information data” refers to electronic data representing physical locations, features, and topographical attributes of an area on the earth’s surface, which may include maps, coordinates, elevation, and other geographic parameters.

The term “spatial structure data” refers to three-dimensional information that describes the physical configuration, arrangement, and relationships of objects and features in a given environment, such as terrain models, buildings, and infrastructures.

The term “user emotion state data” refers to information indicating the psychological or affective condition of a user, which may be derived from physiological signals, voice, facial expressions, or behavioral cues detected during system use.

The term “user characteristic information” refers to data generated by analyzing user emotion state data and other user-related attributes, representing preferences, tendencies, and behavioral patterns of an individual user.

The term “generative information processing model” refers to a computational model, such as a generative artificial intelligence model or machine learning model, capable of producing or inferring outputs, such as optimized travel routes, in response to given input data and contextual parameters.

The term “travel route” refers to a sequence of segments or paths that a user may follow to move from an origin to a destination, generated based on a set of criteria including but not limited to geographic, environmental, and user-specific information.

The term “visualization device” refers to any electronic apparatus or user interface for outputting information in a visual format, such as displays, screens, augmented reality devices, or navigation panels.

The term “external environment” refers to dynamic or static factors outside the user and the system, such as traffic conditions, weather, road closures, or surroundings, which may influence route selection and adaptation.

The term “user input information” refers to feedback, commands, or other interactive data provided by the user to the system, such as route preferences, satisfaction evaluations, or real-time behavioral inputs.

An embodiment for implementing the invention will now be described with reference to the technical scope of the claims.

The system is configured to include a server comprising a processor, terminals which may be user devices such as smartphones, on-board vehicle systems, or dedicated navigation terminals, and visualization devices that display routing information to the user.

The server is equipped with high-capacity storage hardware such as solid-state drives for maintaining geospatial information data and spatial structure data obtained from external databases. The server operates using software components such as geographic information system (GIS) libraries (for example, GDAL or other commonly used GIS tools), and can connect to external geospatial data services via programming interfaces. The server further includes a generative information processing model, implemented as a generative AI engine (such as a large language model or another machine learning system, for instance, a generic cloud-based AI inference API).

The terminals possess sensors such as cameras and microphones, used to capture facial expressions, voice, or other behavioral signals from the user. The terminals may run dedicated emotion recognition software, such as a cloud-based or local emotion recognition API, which interprets the user’s emotion state from multimodal sensor data. The terminal also includes a communications interface to transmit the user emotion state data, along with other user behavioral information, to the server.

The server receives the user emotion state data and analyzes it, possibly in association with historical user-related data, to generate user characteristic information—such as current stress, preferred travel environment, or past behavioral tendencies. This characteristic information is then provided as input, together with updated geospatial information data, to the generative information processing model. The server then formulates an appropriate prompt sentence, which is used to query the AI model in order to produce an optimal travel route. An example of such a prompt sentence is:

Generate an optimal route for a user who is stressed and prefers quiet paths during their commute.

or

Select a commuting route with less traffic and quieter environments suitable for a stressed user.

The generative AI model, upon receiving the prompt sentence and relevant data, synthesizes alternative travel routes that are tailored to both the geographic situation and the emotional or psychological requirements of the user. The server then selects or validates the optimal route from the generated candidates.

The selected optimal travel route is transmitted to the terminal, which utilizes a navigation application (such as one implemented with standard map visualization software libraries—e.g., Mapbox, or other geographic visualization SDKs) to render the recommended route on a display device. The visualization device clearly shows the routing, with annotations emphasizing features related to the user’s current emotional state (such as “quiet area” or “park nearby”).

The user interacts with the system through the terminal, providing feedback on the suggested route—either via direct commands (e.g., touchscreen input) or speech-based input, which may be converted into text using standard speech recognition software. For example, the user may say, “I prefer more green areas,” or “This route is still crowded.” Such feedback is sent from the terminal to the server, where it is used to improve the generative information processing model or to adapt future route suggestions, thereby supporting an adaptive and learning-based navigation experience.

The described system enables the dynamic generation and update of travel routes personalized to the emotional and psychological state of the user, utilizing a combination of sensor-equipped terminals, cloud-based processing, generative AI models, GIS technology, and interactive visualization devices. This technical configuration ensures effective, real-time guidance that enhances user well-being and satisfaction during travel.

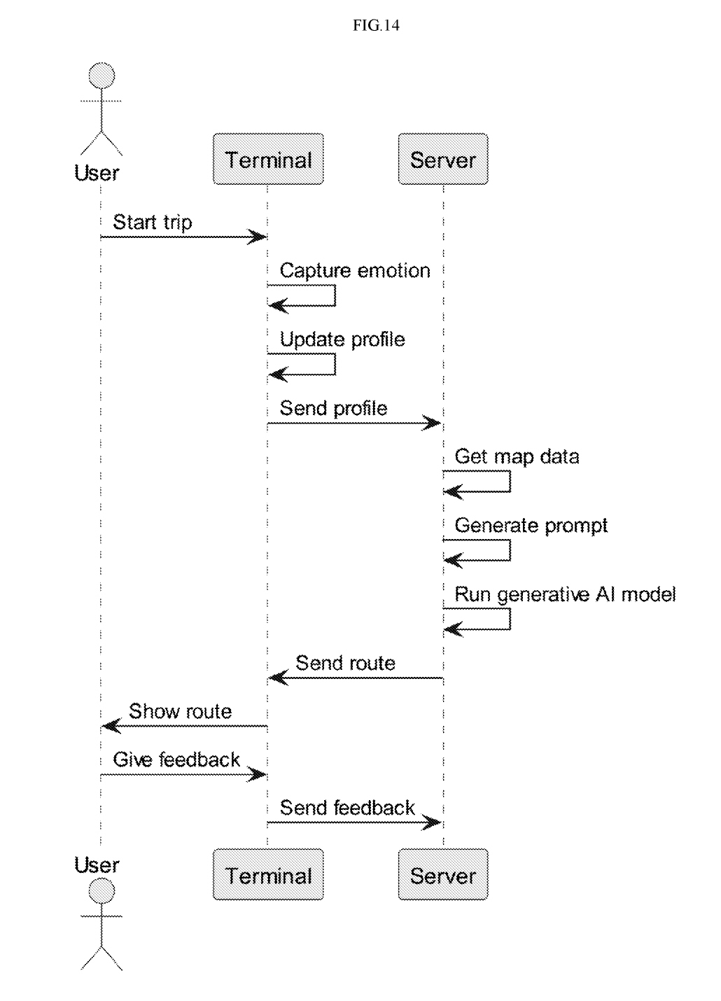

The following describes the processing flow using FIG. 14.

Step 1:

The server obtains geospatial information data and spatial structure data from external data sources by accessing map and satellite data providers via APIs. The server processes the raw input data (such as map tiles, imagery, or 3D models) using geographic information system software to extract relevant features—such as road networks, land use, and area characteristics. The output is an organized set of geospatial and spatial structure data stored in the server’s database, prepared for route computation.

Step 2:

The terminal activates its embedded camera and microphone to capture the user’s facial expressions and vocal cues during the preparation or execution of a trip. The terminal processes these sensory inputs using emotion recognition software, either locally or via a networked cloud service, to analyze emotional signals (such as indicators of stress or calmness). The input for this step is live video and audio data from the user, and the output is a structured set of user emotion state data, typically tagged as categories such as “stressed,” “neutral,” or “happy.”

Step 3:

The terminal receives the user emotion state data, as well as recent movement history and user preference data. The terminal aggregates these inputs and processes them through a profile management application to update the user's profile, thereby producing user characteristic information. As part of the data processing, the terminal may use algorithms to weigh recent emotions more heavily or incorporate historical behavioral patterns. The output is an updated user characteristic profile, represented in a structured format (such as JSON), which is then transmitted securely to the server.

Step 4:

The server collects the user characteristic information and the latest geospatial and spatial structure data. The server composes a prompt sentence that contextualizes the user's current needs for a generative AI model (for example: “Generate a quiet and low-traffic route for a user who is currently stressed”). The input to this step is the user characteristic profile and the geospatial data. The server sends this data and prompt sentence to a generative AI model, which performs reasoning and generates one or more optimal travel route candidates. The output consists of a personalized route suggestion or a set of route options explained with textual justifications.

Step 5:

The server analyzes the route candidates returned by the generative AI model and validates their feasibility by confirming with up-to-date map data and checking for conditions such as road closures or traffic incidents. The input for this step is the output options from the AI model and the latest environment data. The server selects the best route and transmits this selection to the terminal. The output is the finalized optimal route suited for the user's emotional state and current circumstances.

Step 6:

The terminal receives the route selection and, using its map visualization application, renders the route instructions and map annotations on a display device. The input is the digitally encoded optimal route, and the output is the user-facing graphic navigation interface, potentially including highlighted paths, estimated travel time, and context notes (such as “quiet area ahead”).

Step 7:

The user reviews the recommended route as shown on the terminal’s display and, if desired, provides feedback using the terminal’s touchscreen or voice input feature. The user may indicate satisfaction, dissatisfaction, or request changes (for example, by saying, “I would prefer more green zones,” or by selecting an alternative option). The input is direct user interaction with the terminal, and the terminal digitizes and transmits this feedback to the server. The output is updated user input information for further machine learning or adaptive optimization of future routing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

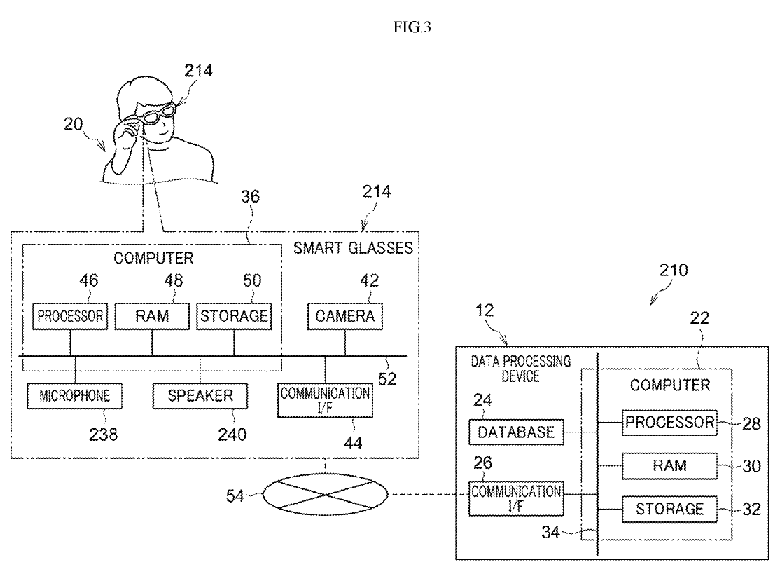

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

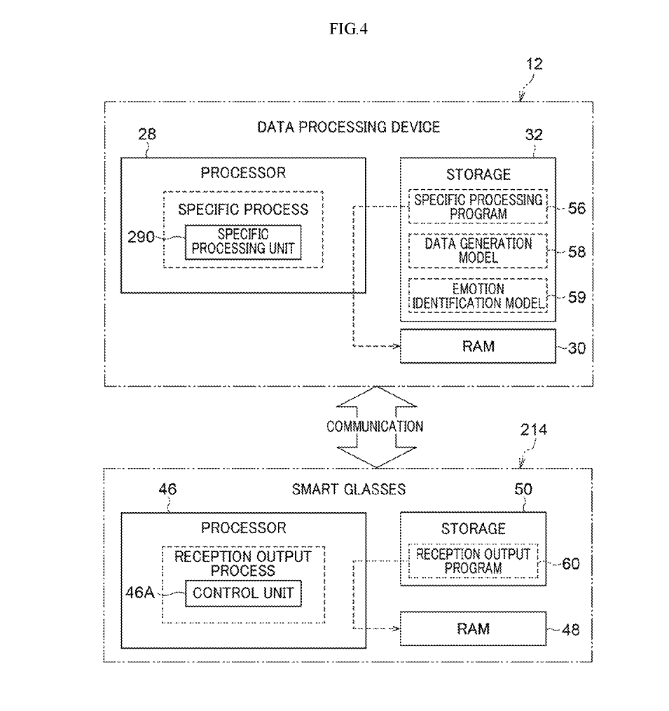

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

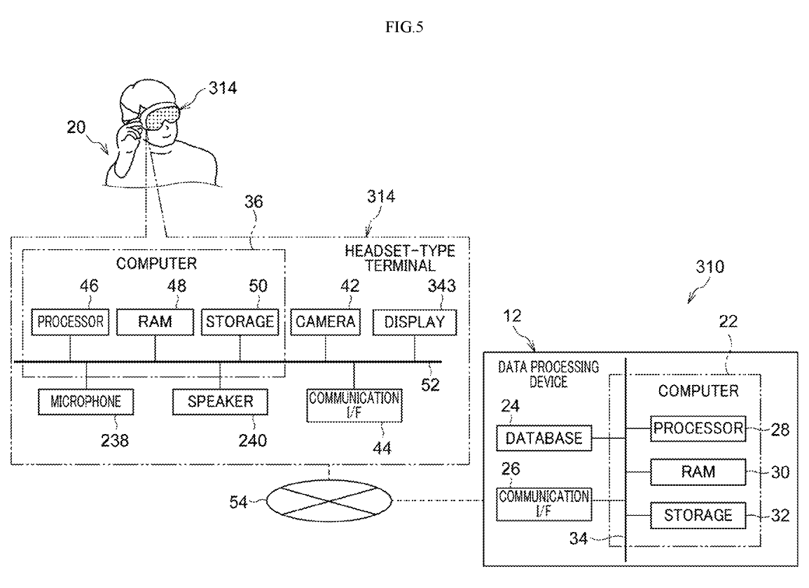

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

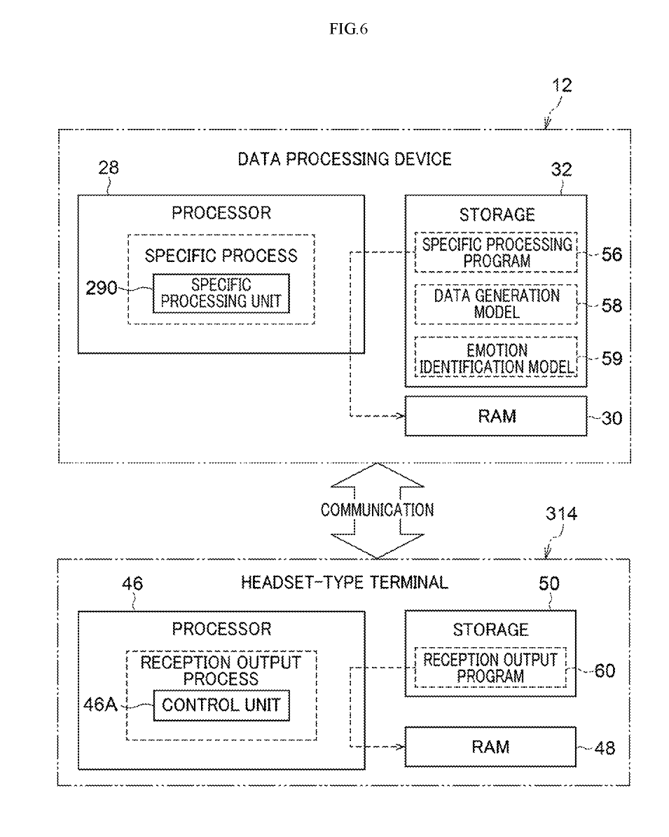

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

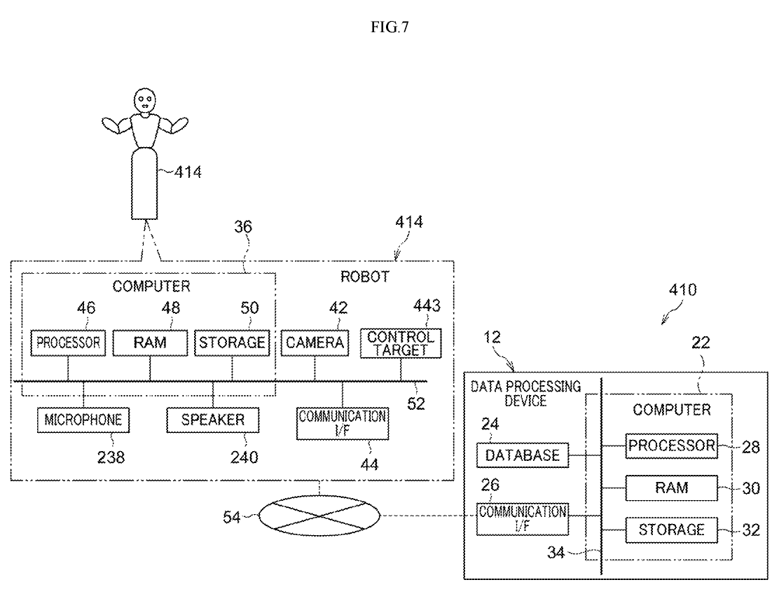

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

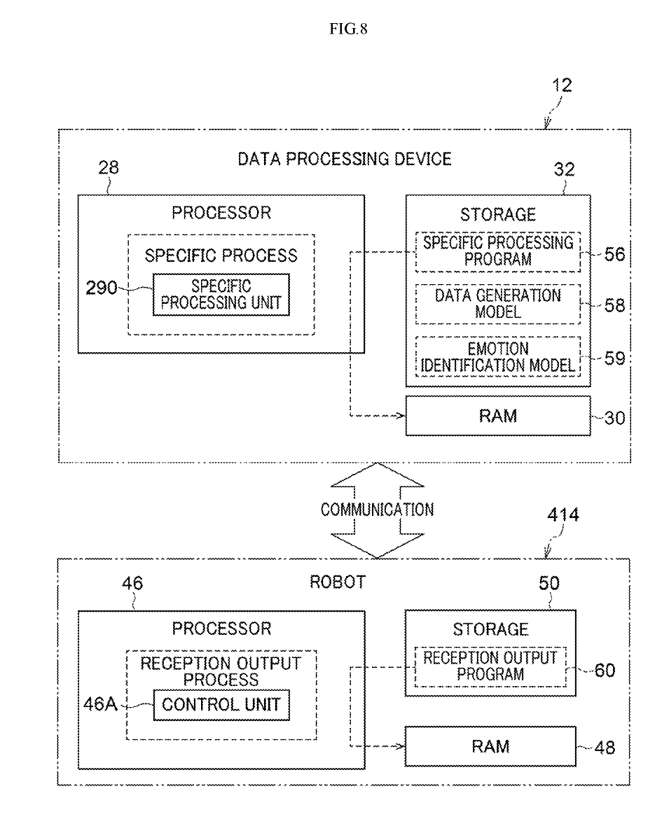

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

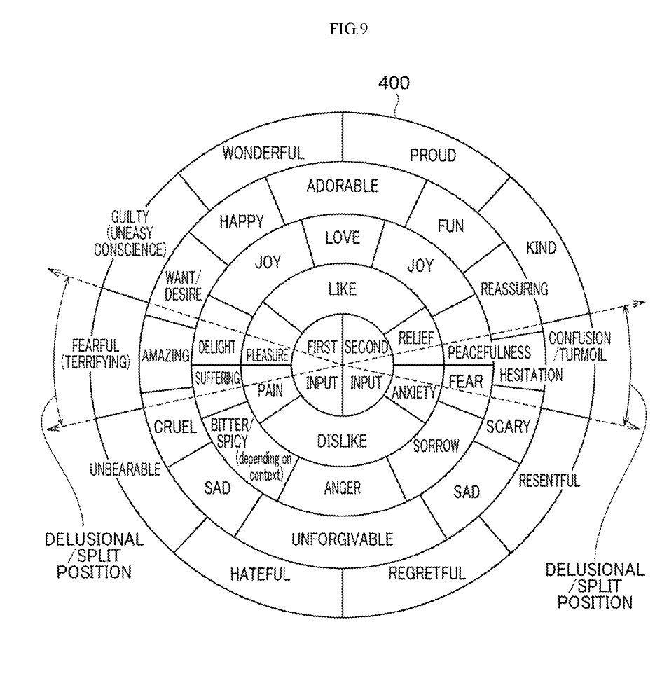

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

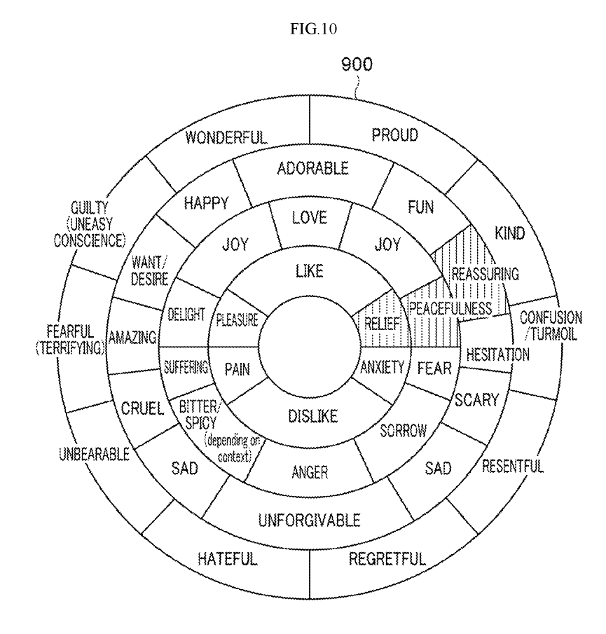

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

Supplementary 1

A system comprising a processor,

wherein the processor is configured to

acquire position information, terrain information, and weather information from external information sources;

generate attribute information of a mobile subject based on the acquired information and past movement history of the mobile subject;

dynamically generate candidate movement routes by inputting environmental information and attribute information into a generative artificial intelligence model using a prompt sentence; and

visually present the generated plurality of candidate movement routes on an output device to allow selection.

Supplementary 2

The system according to supplementary 1,

wherein the processor is configured to

detect a change in external environment or the state of the mobile subject during movement, and

regenerate the candidate movement routes in real time based on the detection by the generative artificial intelligence model.

Supplementary 3

The system according to supplementary 1,

wherein the processor is configured to

continuously train the generative artificial intelligence model using feedback information such as route selection history and external environment information obtained from the mobile subject or the output device, so as to optimize the route generation algorithm.

### Application Example 1

Supplementary 1

A system comprising a processor,

wherein the processor is configured to

acquire external information including geographical information and environmental information,

generate attribute information of an individual based on the acquired geographical information and environmental information,

generate a movement route based on the generated attribute information and external factors,

generate an output prompt sentence for a generative artificial intelligence model in order to calculate an optimal route,

process the output of the generative artificial intelligence model, and

present calculation results from the generative artificial intelligence model to a display device.

Supplementary 2

The system according to supplementary 1,

wherein the processor is configured to

dynamically update the movement route generation and output prompt sentence generation in response to changes in environmental conditions and biometric states detected during movement.

Supplementary 3

The system according to supplementary 1,

wherein the processor is configured to

obtain user selection results and biometric information, and adaptively learn and improve the movement route generation and operation algorithm of the generative artificial intelligence model.

### Example 2

Supplementary 1

A system comprising a processor,

wherein the processor is configured to

acquire spatial information by an information acquisition unit,

determine a user's emotional state from audio information or video information by an emotion recognition unit,

generate individual characteristic information based on behavioral history information and emotional state information by a characteristic information generation unit,

operate a generative artificial intelligence model using external information and characteristic information, and generate a proposed travel route as presentation content by a route generation unit that considers the emotional state and external factors, and

output the generated travel route in a visual or auditory manner to a display device by a presentation unit.

Supplementary 2

The system according to supplementary 1,

wherein the processor is configured to dynamically generate a prompt sentence for input to the generative artificial intelligence model in response to changes in the user's emotional state information or external information obtained during movement, and re-present the travel route.

Supplementary 3

The system according to supplementary 1,

wherein the processor is configured to adaptively update processing of the characteristic information generation unit and the route generation unit based on feedback information obtained from the user.

### Application Example 2

Supplementary 1

A system comprising a processor,

wherein the processor is configured to

acquire geospatial information data and spatial structure data,

analyze user emotion state data and generate user characteristic information based on said analysis,

generate an optimal travel route by using a generative information processing model based on the user characteristic information and the geospatial information data, and

present the generated optimal travel route to a visualization device.

Supplementary 2

The system according to supplementary 1,

wherein the processor is configured to

dynamically update the travel route generation process based on changes in the user's emotion state or external environment during travel.

Supplementary 3

The system according to supplementary 1,

wherein the processor is configured to

adaptively optimize the generative information processing model or a route selection algorithm by learning from user input information.

What is claimed is:

1. A system comprising a processor,
wherein the processor is configured to:
acquire satellite images and three-dimensional map data,
generate traveler profile information using the acquired information,
dynamically select a travel route based on external factors, and
present the travel route on a display device.

2. The system according to claim 1,
wherein the processor is configured to dynamically updates the travel route generation in response to changes in external environment during travel.

3. The system according to claim 1,
further comprising a feedback learning function in which the processor learns from traveler feedback and adapts the route generation algorithm accordingly.
